(19) United States
(12) Patent Application Publication
(10) Pub. No.: US 2024/0425954 A1
(43) Pub. Date: Dec. 26, 2024

(54) MISCH-METAL PERMANENT MAGNETIC MATERIAL AND METHOD FOR PREPARING THE SAME BASED ON SINTERING AND MULTI-STEP DIFFUSION

(71) Applicants: Zhejiang University, Hangzhou (CN); BAOTOU RESEARCH INSTITUTE OF RARE EARTHS, Baotou (CN)

(72) Inventors: Mi YAN, Hangzhou (CN); Jiaying JIN, Hangzhou (CN); Wang CHEN, Hangzhou (CN); Chen WU, Hangzhou (CN); Shaoqing REN, Hangzhou (CN); Bo XIN, Hangzhou (CN)

(21) Appl. No.: 18/825,029

(22) Filed: Sep. 5, 2024

Related U.S. Application Data
(63) Continuation of application No. PCT/CN2024/116928, filed on Sep. 4, 2024.

(30) Foreign Application Priority Data
Oct. 24, 2023 (CN) 202311381495.2

(51) Int. Cl. C22C 28/00; H01F 1/053

(52) U.S. Cl. CPC C22C 28/00; H01F 1/0536

(57) ABSTRACT

A preparation method of a misch-metal permanent magnetic material based on sintering and multi-step diffusion is provided. A sintered substrate magnet is prepared by induction melting, strip casting, hydrogen decrepitation, jet milling, magnetic alignment, isostatic pressing and sintering. A first diffusion source and a second diffusion source are prepared, where the first diffusion source is a light rare-earth metal or its alloy, and the second diffusion source is a light-heavy rare-earth combination or its alloy. The sintered substrate magnet is sequentially subjected to a first vacuum diffusion with the first diffusion source and a second vacuum diffusion with the second diffusion source. The resultant product is subjected to low-temperature tempering to give the desired misch-metal permanent magnetic material.

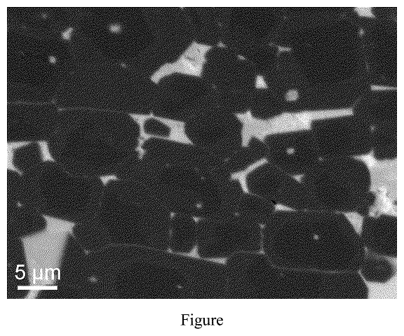

### CROSS-REFERENCE TO RELATED APPLICATIONS

This application is a continuation of International Patent Application No. PCT/CN2024/116928, filed on Sep. 4, 2024, which claims the benefit of priority from Chinese Patent Application No. 202311381495.2, filed on Oct. 24, 2023. The content of the aforementioned application, including any intervening amendments thereto, is incorporated herein by reference in its entirety.

### TECHNICAL FIELD

This application relates to rare-earth permanent magnets, and more particularly to a misch-metal permanent magnetic material and a method for preparing the same based on sintering and multi-step diffusion.

### BACKGROUND

Permanent magnets containing neodymium (Nd), iron (Fe) and boron (B), hereinafter referred to as the NdFeB permanent magnets, count as the strongest permanent magnetic material in the world with excellent magnetic properties. NdFeB permanent magnets have been widely used in the automotive industry, medical devices, wind power generation, electronic information, and aerospace. However, the rapid growth in the demand for NdFEB permanent magnetic materials has led to the overconsumption of major rare-earth (RE) raw materials such as Nd, Pr, dysprosium (Dy), and terbium (Tb). Usually, Nd and Pr are co-added due to the similar intrinsic magnetic properties of Nd₂Fe₁₄B and Pr₂Fe₁₄B compounds. Partial Dy and Tb substitution for Nd and Pr are commonly utilized to enhance the coercivity and thermal stability, due to the higher magneto-crystalline anisotropy field HA of Dy₂Fe₁₄B and Tb₂Fe₁₄B compounds than (Nd, Pr)₂Fe₁₄B. Moreover, the RE raw materials such as Nd, Pr, Dy and Tb metals are obtained through a complicated process including separation, refining, and purification, which will inevitably cause the waste discharge and environment pollution. The misch-metal, a typical RE mixture La—Ce—Pr—Nd, due to the absence of complex separation and purification process, is considered cost-effective to be applied to RE permanent magnetic materials, and can effectively consume the abundant deposit of some RE raw materials such as lanthanum (La) and cerium (Ce), thereby balancing the use of RE resources.

Taking the misch-metal from Baiyun Ebo in China as an example, the proportion of La and Ce is more than 75%, the proportion of Nd and Pr is lower than 25%, and other RE elements such as Dy and Tb account for less. Due to the poor intrinsic magnetic property of the tetragonal hard magnetic main phase composed of La and Ce, the magneto-crystalline anisotropy field HA and saturation magnetization Ms of the (La, Ce)₂Fe₁₄B phase are significantly lower than those of the (Nd, Pr)₂Fe₁₄B phase. Thus, compared to the traditional NdFEB magnets prepared from Nd—Pr alloy, the RE permanent magnets directly prepared from the misch-metal have significantly poorer magnetic properties, especially the extremely lower coercivity (even <1 kOe), which are widely recognized to be incapable for commercialization.

The low coercivity of misch-metal permanent magnetic materials mainly comes from two constraints. Intrinsically, due to the high proportion of La and Ce in the misch-metal, the lower HA of the resultant tetragonal hard magnetic main phase limits the coercivity of the magnet. Extrinsically, REFe₂ and RE₂O₃ intergranular phases with high melting points are prone to be accumulated in the misch-metal permanent magnets, which are harmful to the liquid-phase-sintering and quick densification of final bulk magnets. Meanwhile, the absence of RE-rich grain boundary phases with low melting point will cause the direct exchange coupling between adjacent ferromagnetic main phases that cannot be well isolated, resulting in the low coercivity of the magnet.

The grain boundary diffusion (GBD) technology is widely recognized as an effective method to enhance the coercivity of NdFeB permanent magnetic materials. In the traditional GBD process, the NdFEB magnet is coated with pure RE or its alloys, and then subjected to one-step diffusion treatment and aging treatment to make the surface diffusion source enter the interior of magnets, so as to modify the components of the hard magnetic main phase, optimize the composition and distribution of the grain boundary phases, thereby enhancing the coercivity of the magnet. For misch-metal permanent magnetic materials, the interaction of multiple RE elements such as La, Ce, Nd and Pr yields a more complicated composition and distribution of the hard magnetic main phase and the grain boundary phase. Therefore, the traditional GBD method has been proven with limited diffusion depth and insufficient microstructural modification effect, failing to significantly enhance the coercivity. Therefore, to solve the problem of low coercivity of misch-metal permanent magnetic materials, it is necessary to design a misch-metal permanent magnet substrate into which the diffusion source can easily diffuse, and simultaneously a novel GBD method with effective diffusion sources.

### SUMMARY

In view of the deficiencies in the prior art, this application provides a high coercivity misch-metal permanent magnetic material and a method for preparing the same based on sintering and multi-step diffusion.

Technical solutions of this application are described as follows.

In a first aspect, this application provides a method for preparing a misch-metal permanent magnetic material based on sintering and multi-step diffusion, comprising:
(1) subjecting a raw misch-metal permanent magnetic material to induction melting, strip casting, hydrogen decrepitation, jet milling, magnetic alignment, isostatic pressing and sintering to obtain a sintered substrate magnet;
(2) preparing at least one first diffusion source and a second diffusion source, wherein the at least one first diffusion source is each independently a light rare-earth metal or an alloy thereof, and the second diffusion source is a light-heavy rare-earth combination or an alloy thereof;
(3) subjecting the sintered substrate magnet to a first vacuum diffusion with the at least one first diffusion source to obtain a first intermediate product, wherein each of the at least one first diffusion source is less than 3% by weight of the sintered substrate magnet, and the first vacuum diffusion is performed at 600-950° C. for 1-6 hours;
(4) subjecting the first intermediate product to a second vacuum diffusion with the second diffusion source to obtain a second intermediate product; wherein the second diffusion source is less than 1% by weight of the sintered substrate magnet, and the second vacuum diffusion is performed at 800-950° C. for 2-10 hours; and
(5) subjecting the second intermediate product to tempering at 450-650° C. for 0.5-5 hours to obtain the misch-metal permanent magnetic material.

In an embodiment, the thickness of the sintered substrate magnet may be beyond the preferred range of multi-step diffusion. Additional machining such as wire-electrode cutting may be required. Therefore, before the diffusion step, it may be required to cut the sintered substrate magnet to achieve the desired multi-step diffusion effect. However, the multi-step diffusion method does not place strict requirements for a high finish surface on the sintered substrate magnet, so there are no stringent requirements for the cut surface quality of the magnet.

In an embodiment, composition of the sintered substrate magnet, in weight percentage, is [A₁₋ₐ(Ce₁₋ₓMMₓ)ₐ]_{b}Fe_{bal}R_{c}B_{d}GaₑAl_{f}, wherein A is selected from the group consisting of neodymium (Nd), praseodymium (Pr) and a combination thereof; Ce represents cerium element; MM is a misch-metal comprising 50-60% by weight of Ce, 20-35% by weight of lanthanum (La), 5-10% by weight of Pr, 10-20% by weight of Nd, and less than 2% by weight of other impurity elements; Fe represents iron element; bal represents balance, namely, 100-b-c-d-e-f; R is selected from the group consisting of cobalt (Co), nickel (Ni), copper (Cu), molybdenum (Mo), niobium (Nb), silicon (Si), titanium (Ti), vanadium (V), zirconium (Zr) and a combination thereof; B represents boron element; Ga represents gallium element; Al represents aluminum element; and a, x, b, c, d, e and f satisfy the following conditions: 0.5≤a≤1, 0.5≤x≤0.95, 30≤b≤35, 0.2≤c≤3, 0.80≤d≤1, 0.2≤e≤2, 0.1≤f≤1, and 0.4≤e+f≤2.5.

In an embodiment, A is Nd or Pr with a purity greater than 99.5%, or a Nd—Pr alloy.

In an embodiment, 0.7≤a≤1, 0.7≤x≤0.85, 31≤b≤32.5, 0.7≤c≤1.5, 0.88≤d≤0.95, 0.3≤e≤0.6, 0.2≤f≤0.7, and 0.5≤e+f≤1.3.

In an embodiment, the at least one first diffusion source, in weight percentage, is each independently A1_{g}M1_{1-g}, wherein A1 is selected from the group consisting of Nd, Pr, Ce, La and a combination thereof; when A1 is an element combination comprising Nd or/and Pr, a weight percentage of Nd and/or Pr in A1 is required to be higher than 60%; and M1 is selected from the group consisting of Al, Cu, Ga and a combination thereof; and the second diffusion source, in weight percentage, is A2ₕA3ᵢM2₁₋ₕ₋ᵢ, wherein A2 is selected from the group consisting of Nd, Pr, Ce, La and a combination thereof, A3 is selected from the group consisting of dysprosium (Dy), terbium (Tb) and a combination thereof; and M2 is selected from the group consisting of Al, Cu, Ga, Hydrogen (H) and a combination thereof; and g, h, and i satisfy the following conditions: 0.6≤g≤1, 0.4≤h≤0.8, and 0.1≤i≤0.6.

In an embodiment, the number of the at least one first diffusion source is 1-3, and the 1-3 first diffusion sources vary in composition; and in step (3), the first vacuum diffusion is performed 1-3 times respectively with the 1-3 first diffusion sources (that is, the number of the first diffusion sources equals to the number of times the first vacuum diffusion is performed).

In an embodiment, the first vacuum diffusion and the second vacuum diffusion are each performed at a furnace pressure of ≤10⁻³ Pa.

It is to be noted that the induction melting, strip casting, hydrogen decrepitation, jet milling, magnetic alignment, isostatic pressing and sintering used in the method of preparing the sintered substrate magnet are common technologies in the field. For example, the temperature of induction melting usually needs to be higher than that of the highest melting point of the raw materials. The strip casting is generally controlled to have a copper roller line speed of 1-5 m/s. In the hydrogen decrepitation process, the strip casting flakes are generally loaded into a stainless steel tank, with the chamber pressure of the stainless steel tank lower than 10⁻² Pa, and the stainless steel tank is subsequently passed with high purity hydrogen gas. Nitrogen is generally chosen as the medium for the jet milling. The sintering is generally held at a temperature range of 1000-1100° C. for 1-4 hours.

In a second aspect, this application also provides a misch-metal permanent magnetic material prepared by the method as described.

Compared with the prior art, this application has the following merits.

1) This application addresses the low coercivity problem of misch-metal permanent magnetic materials, and promotes the commercial application of misch-metal permanent magnetic materials. The method in this application can exert the advantages of misch-metal, and significantly reduce the cost of raw materials for magnets. Moreover, this application makes full use of those rare earths with large deposit such as La and Ce, thereby effectively balancing the utilization of RE resources.

2) In the method provided herein, the composition of the sintered substrate magnet is specially designed, where the B content is controlled at a lower level, Ga and Al elements are co-added, and Ce element is co-added with MM. By this way, in the sintered substrate magnet, the fraction of RE oxides with high melting point and high oxygen content is reduced, and a new RE/Ga/Al-rich grain boundary phase is generated, which increases the grain boundary diffusion channel and promotes the diffusion, thereby facilitating the subsequent preparation of high-coercivity misch-metal permanent magnetic materials.

3) The application designs a followed multi-step diffusion method. The light rare earths with low melting point or their alloys are first selected for grain boundary diffusion. This type of diffusion source can form a Nd/Pr-rich magnetically hardening shell surrounding the La/Ce-rich main phase grain epitaxial layer after diffusing into the sintered substrate magnet, and at the same time new grain boundary phases are formed, which can provide a channel for the subsequent diffusion using the second diffusion sources, thereby improving the diffusion efficiency. The number of vacuum diffusion treatments, diffusion source, diffusion temperature and diffusion time can be determined according to the composition of the sintered substrate magnet and magnetic performance requirements of the final magnetic material. Subsequently, light-heavy rare-earth combination or their alloys are selected for grain boundary diffusion. Since the heavy rare-earth (e.g., Dy and Tb) is not prone to exist in the grain boundary phases such as RE₆(Fe,Ga,Al,Cu)₁₄, more Dy/Tb enters the main phase to form Dy/Tb-rich magnetically hardening shell, as displayed in FIGURE. Thus, the formation of the double magnetically hardening shell layers can greatly improve the coercivity of the final misch-metal permanent magnetic material. In the multi-step diffusion, the light rare-earth metal or the alloy thereof with low melting points are first selected, and then the light-heavy rare-earth combination or the alloy thereof are selected for diffusion, thereby forming a shell layer region with enhanced gradient of magneto-crystalline anisotropy field from the core to the edge of the main-phase grains, and effectively suppressing the preferential nucleation of reversal domains at the edges of the grains. Meanwhile, the multi-step diffusion method can effectively avoid the accumulation of heavy rare-earth Dy/Tb at grain boundaries in the conventional GBD process, thereby improving the utilization of the heavy rare-earth. The amount of the second diffusion source can be reduced to 1% by weight of the sintered substrate magnet, revealing that the coercivity can be increased with a significant reduction in the amount of heavy rare-earth metal. By means of the final tempering treatment, continuous non-ferromagnetic grain boundary phases such as RE₆(Fe,Ga,Al,Cu)₁₄ enriched with La and Ce are further formed, which can effectively weaken the short-range exchange coupling between the ferromagnetic main phase grains, thereby preparing the high coercivity misch-metal permanent magnetic materials.

4) The application makes full use of the synergistic effects between multi-rare-earth elements (La, Ce, Nd, Pr, Dy, Tb) and non-rare-earth elements (Cu, Ga, Al, Co, Ni, Mo, Nb, Ti). Based on the process of sintering and multi-step diffusion and tempering, an inhomogeneous structure is constructed. This inhomogeneity is not only shown between the double magnetically hardening shell layers and the core region inside the main phase grains, but also in the various grain boundary phase regions formed in different preparation stages. The application itself is also efficient and productive to be carried out on a relatively large scale. The present invention is directed to the reduced utilization of heavy rare-earths Dy and Tb, and high-value utilization of misch-metal from Baiyun Ebo (Baotou city, Inner Mongolia Autonomous Region, China).

### BRIEF DESCRIPTION OF THE DRAWINGS

This FIGURE illustrates a microstructure of a misch-metal permanent magnetic material obtained in Example 4 of the present disclosure.

### DETAILED DESCRIPTION OF EMBODIMENTS

The present disclosure will be further described in detail below in conjunction with the embodiments, which are not intended to limit the disclosure. It should be noted that embodiments of the present disclosure and the features therein may be combined with each other in the case of no contradiction.

### Example 1

A sintered substrate magnet was prepared through induction melting, strip casting, hydrogen decrepitation, jet milling, magnetic alignment, isostatic pressing and sintering steps, which was represented by [(Nd_{0.2}(Ce_{0.3}MM_{0.7})_{0.8}]_{31.5}Fe_{bal}Co_{0.6}Cu_{0.2}Zr_{0.15}B_{0.95}Ga_{0.3}Al_{0.2} in weight percent. Three kinds of powdered diffusion sources were prepared, respectively Pr_{0.77}Ce_{0.12}Ga_{0.11}, Pr_{0.95}Al_{0.05}, and Nd_{0.64}Dy_{0.25}Ga_{0.11}, in weight percent. Accordingly, the three diffusion sources were 2%, 2% and 0.8% by weight of the sintered substrate magnet, respectively. A three-step diffusion method was used, where the first-step diffusion was performed with Pr_{0.77}Ce_{0.12}Ga_{0.11} at 850° C. for 2 h, the second-step diffusion was performed with Pr_{0.95}Al_{0.05} at 850° C. for 1 h, and the third-step diffusion was performed with Nd_{0.64}Dy_{0.25}Ga_{0.11} at 900° C. for 6 h. The magnet was then subjected to tempering at 500° C. for 4 h to obtain a high-coercivity misch-metal permanent magnetic material, which was tested using an AMT-4 permanent magnet test system. The test results showed that the coercivity of the resultant magnet reached 15.5 kOe.

### Comparative Example 1

The Comparative Example 1 differed from Example 1 in the selection of the diffusion source, the amount of the diffusion source, and the diffusion method. Specifically, only one diffusion source represented by Nd_{0.64}Dy_{0.25}Ga_{0.11} in weight percent was prepared, and the powdered diffusion source was 1% by weight of the sintered substrate magnet. A one-step diffusion method was performed with the diffusion source Nd_{0.64}Dy_{0.25}Ga_{0.11} at 900° C. for 6 h. The magnet was subjected to tempering at 500° C. for 4 h. The test results of the AMT-4 permanent magnet test system showed that the coercivity of the resultant magnet was 10.8 kOe, which was much lower than that of Example 1.

### Comparative Example 2

The Comparative Example 2 differed from Example 1 in the selection of the diffusion source, the amount of the diffusion source, and the diffusion method. Specifically, only one diffusion source represented by Nd_{0.64}Dy_{0.25}Ga_{0.11} in weight percent was prepared, and the powdered diffusion source was 3% by weight of the sintered substrate magnet. A one-step diffusion method was performed with the diffusion source Nd_{0.64}Dy_{0.25}Ga_{0.11} at 900° C. for 6 h. The magnet was subjected to tempering at 500° C. for 4 h. The test results of the AMT-4 permanent magnet test system showed that the coercivity of the resultant magnet was 11.0 kOe, which was much lower than that of Example 1.

### Comparative Example 3

The Comparative Example 3 differed from Example 1 in the amount of the second diffusion source. Specifically, three kinds of powdered diffusion sources were prepared, respectively Pr_{0.77}Ce_{0.12}Ga_{0.11}, Pr_{0.95}Al_{0.05}, and Nd_{0.64}Dy_{0.25}Ga_{0.11}, in weight percent. Accordingly, the three diffusion sources were 2%, 2% and 3% by weight of the sintered substrate magnet, respectively. The test results of the AMT-4 permanent magnet test system showed that the coercivity of the resultant magnet was 15.0 kOe, which was still lower than that of Example 1.

### Example 2

A sintered substrate magnet was prepared through induction melting, strip casting, hydrogen decrepitation, jet milling, magnetic alignment, isostatic pressing and sintering steps, which was represented by [(Nd_{0.3}(Ce_{0.15}MM_{0.85})_{0.7}]₃₁Fe_{bal}Co_{0.85}Cu_{0.25}Nb_{0.2}Ti_{0.2}B_{0.88}Ga_{0.6}Al_{0.7} in weight percent. Two kinds of powdered diffusion sources were prepared, respectively, Nd_{0.76}Pr_{0.19}Al_{0.05} and Pr_{0.58}Dy_{0.27}Cu_{0.15}, in weight percent. Accordingly, two diffusion sources were 2.5% and 0.6% by weight of the sintered substrate magnet, respectively. A two-step diffusion method was used, where the first-step diffusion was performed with Nd_{0.76}Pr_{0.19}A10.05 at 850° C. for 2 h, and the second-step diffusion was performed with Pr_{0.58}Dy_{0.27}Cu_{0.15} at 800° C. for 10 h. The magnet was then subjected to tempering at 480° C. for 5 h to obtain the high-coercivity misch-metal permanent magnetic material which was tested using an AMT-4 permanent magnet test system. The test results showed that the coercivity of the resultant magnet reached 15.3 kOe.

### Comparative Example 4

The Comparative Example 4 differed from Example 2 in the selection of the diffusion source and the diffusion method. Specifically, only one diffusion source represented by Nd_{0.76}Pr_{0.19}Al_{0.05} in weight percent was prepared, and the diffusion source was 2.5% by weight of the sintered substrate magnet. A one-step diffusion method was performed with the diffusion source Nd_{0.76}Pr_{0.19}Al_{0.05} at 890° C. for 6 h. The magnet was subjected to tempering at 480° C. for 5 h. The test results of the AMT-4 permanent magnet test system showed that the coercivity of the resultant magnet was 10.2 kOe, which was much lower than that of Example 2.

### Comparative Example 5

The Comparative Example 5 differed from Example 2 in the selection of the diffusion source and the diffusion method. Specifically, only one diffusion source represented by Nd_{0.76}Pr_{0.19}Al_{0.05} in weight percent was prepared, and the diffusion source was 2.5% by weight of the sintered substrate magnet. A one-step diffusion method was performed with the diffusion source Nd_{0.76}Pr_{0.19}Al_{0.05} at 850° C. for 2 h. The magnet was subjected to tempering at 480° C. for 5 h. The test results of the AMT-4 permanent magnet test system showed that the coercivity of the resultant magnet was 8.5 kOe, which was much lower than that of Example 2.

### Comparative Example 6

The Comparative Example 6 differed from Example 2 in the selection of the diffusion source, the amount of the diffusion source, and the diffusion method. Specifically, only one diffusion source represented by Nd_{0.76}Pr_{0.19}Al_{0.05} in weight percent was prepared, and the diffusion source was 5% by weight of the sintered substrate magnet. A one-step diffusion method was performed with the diffusion source Nd_{0.76}Pr_{0.19}Al_{0.05} at 890° C. for 6 h. The magnet was subjected to tempering at 480° C. for 5 h. The test results of the AMT-4 permanent magnet test system showed that the coercivity of the resultant magnet was 10.5 kOe, which was like that of Comparative Example 4 and much lower than that of Example 2.

### Comparative Example 7

The Comparative Example 7 differed from Example 2 in the amount of the diffusion source. Specifically, two kinds of powdered diffusion sources were prepared, respectively, Nd_{0.76}Pr_{0.19}Al_{0.05} and Pr_{0.58}Dy_{0.27}Cu_{0.15}, in weight percent. Accordingly, two diffusion sources were 5% and 0.6% by weight of the sintered substrate magnet, respectively. The test results of the AMT-4 permanent magnet test system showed that the coercivity of the resultant magnet was 13.8 kOe, which was lower than that of Example 2.

### Comparative Example 8

The Comparative Example 8 differed from Example 2 in the temperature and time of the second-step diffusion. Specifically, a two-step diffusion method was used, where the first-step diffusion was performed with Nd_{0.76}Pr_{0.19}Al_{0.05} at 850° C. for 2 h, and the second-step diffusion was performed with Pr_{0.58}Dy_{0.27}Cu_{0.15} at 770° C. for 10 h. The magnet was then subjected to tempering at 480° C. for 5 h. The test results of the AMT-4 permanent magnet test system showed that the coercivity of the resultant magnet was 13.2 kOe, which was much lower than that of Example 2.

### Example 3

A sintered substrate magnet was prepared through induction melting, strip casting, hydrogen decrepitation, jet milling, magnetic alignment, isostatic pressing and sintering steps, which was represented by (Ce_{0.2}MM_{0.8})_{32.5}Fe_{bal}Ni_{0.25}Cu_{0.25}Ti_{0.2}B_{0.92}Ga_{0.4}Al_{0.4} in weight percent. Two kinds of powdered diffusion sources were prepared, respectively, Pr_{0.94}Al_{0.03}Ga_{0.03} and Pr_{0.75}Tb_{0.12}Ga_{0.11}H_{0.02}, in weight percent. Accordingly, two diffusion sources were 1.5% and 0.8% by weight of the sintered substrate magnet, respectively. A two-step diffusion method was used, where the first-step diffusion was performed with Pr_{0.94}Al_{0.03}Ga_{0.03} at 800° C. for 2 h, and the second-step diffusion was performed with Pr_{0.75}Tb_{0.12}Ga_{0.11}H_{0.02} at 900° C. for 6 h. The magnet was then subjected to tempering at 500° C. for 3 h to obtain the high-coercivity misch-metal permanent magnetic material, which was tested using an AMT-4 permanent magnet test system. The test results showed that the coercivity of the resultant magnet reached 14.1 kOe.

### Comparative Example 9

The Comparative Example 9 differed from Example 3 was in the components of the sintered substrate magnet, which increased the content of element B and decreased the contents of elements Ga and A1. The sintered substrate magnet was represented by (Ce_{0.2}MM_{0.8})_{32.5}Fe_{bal}Ni_{0.25}Cu_{0.25}Ti_{0.2}B_{1.1}. The test results of the AMT-4 permanent magnet test system showed that the coercivity of the resultant magnet was 7.8 kOe, which was much lower than that of Example 3.

### Comparative Example 10

The Comparative Example 10 differed from Example 3 in the components of the sintered substrate magnet, which increased the content of element B and decreased the contents of elements Ga. The sintered substrate magnet was represented by (Ce_{0.2}MM_{0.8})_{32.5}Fe_{bal}Ni_{0.25}Cu_{0.25}Ti_{0.2}B_{1.1}Al_{0.4}. The test results of the AMT-4 permanent magnet test system showed that the coercivity of the resultant magnet was 9.0 kOe, which was much lower than that of Example 3.

### Comparative Example 11

The Comparative Example 11 differed from Example 3 in the diffusion source in the second-step diffusion, which was represented by Pr_{0.85}Tb_{0.02}Ga_{0.11}H_{0.02}. The diffusion source in the second-step diffusion was 0.8% by weight of the sintered substrate magnet. The test results of the AMT-4 permanent magnet test system showed that the coercivity of the resultant magnet was 10.4 kOe, much lower than that of Example 3.

### Example 4

A sintered substrate magnet was prepared through induction melting, strip casting, hydrogen decrepitation, jet milling, magnetic alignment, isostatic pressing and sintering steps, which was represented by [(Nd_{0.4}(Ce_{0.10}MM_{0.90})_{0.6}]₃₁Fe_{bal}CO_{0.75}Cu_{0.25} V_{0.05}Ti_{0.20}B_{0.85}Ga_{0.25}Al_{0.70} in weight percent. Two kinds of powdered diffusion sources were prepared, respectively, Pr_{0.89}Ga_{0.11} and Pr_{0.69}La_{0.12}Tb_{0.13}Al_{0.03}Ga_{0.03}, in weight percent. Accordingly, two diffusion sources were 1.0% and 0.5% by weight of the sintered substrate magnet, respectively. A two-step diffusion method was used, where the first-step diffusion was performed with Pr_{0.89}Ga_{0.11} at 850° C. for 3 h, and the second-step diffusion was performed with Pr_{0.69}La_{0.12}Tb_{0.13}Al_{0.03}Ga_{0.03} at 920° C. for 6 h. The magnet was then subjected to tempering at 480° C. for 3.5 h to obtain the high-coercivity misch-metal permanent magnetic material which was tested using an AMT-4 permanent magnet test system. The test results showed that the coercivity of the resultant magnet reached 16.3 kOe.

### Comparative Example 12

The Comparative Example 12 differed from Example 4 in the diffusion source used in the first-step diffusion, which was represented by Pr_{0.34}La_{0.55}Ga_{0.11}. The diffusion source in the first-step diffusion was 1.0% by weight of the sintered substrate magnet. The test results of the AMT-4 permanent magnet test system showed that the coercivity of the resultant magnet was 11.6 kOe, which was much lower than that of Example 4.

### Comparative Example 13

The Comparative Example 13 differed from Example 4 in the diffusion order in the two-step diffusion, where the first-step diffusion was performed with Pr_{0.69}La_{0.12}Tb_{0.13}Al_{0.03}Ga_{0.03} at 920° C. for 6 h, and the second-step diffusion was performed with Pr_{0.89}Ga_{0.11} at 850° C. for 3 h. The test results of the AMT-4 permanent magnet test system showed that the coercivity of the resultant magnet was 12.1 kOe, much lower than that of Example 4.

### Example 5

A sintered substrate magnet was prepared through induction melting, strip casting, hydrogen decrepitation, jet milling, magnetic alignment, isostatic pressing and sintering steps, which was represented by [(Nd_{0.40}Pr_{0.10}(Ce_{0.30}MM_{0.70})_{0.50}]₃₁Fe_{bal}Co_{0.90}Cu_{0.25}Mo_{0.10}Si_{0.20}B_{0.90}Ga_{0.40}Al_{0.50} in weight percent. Two kinds of powdered diffusion sources were prepared, respectively, Nd_{0.18}Pr_{0.60}La_{0.11}Ga_{0.11} and Nd_{0.10}Pr_{0.48}Ce_{0.06}Dy_{0.13}Tb_{0.07}Cu_{0.16}, in weight percent. Accordingly, two diffusion sources were 2.0% and 0.5% by weight of the sintered substrate magnet, respectively. A two-step diffusion method was used, where the first-step diffusion was performed with Nd_{0.18}Pr_{0.6}La_{0.11}Ga_{0.11} at 800° C. for 6 h, and the second-step diffusion was performed with Nd_{0.1}Pr_{0.48}Ce_{0.06}Dy_{0.13}Tb_{0.07}Cu_{0.16} at 850° C. for 6 h. The magnet was then subjected to tempering at 520° C. for 3 h to obtain the high-coercivity misch-metal permanent magnetic material which was tested using an AMT-4 permanent magnet test system. The test results showed that the coercivity of the resultant magnet reached 17.5 kOe.

### Comparative Example 14

The Comparative Example 14 differed from Example 5 in the components of the sintered substrate magnet. The sintered substrate magnet was represented by [(Nd_{0.40}Pr_{0.10}(Ce_{0.50}MM_{0.50})_{0.50}]₃₁Fe_{bal}Co_{0.90}Cu_{0.25}Mo_{0.1}Si_{0.20}B_{0.90}Ga_{0.15}Al_{0.10}. A two-step diffusion method was used. The test results of the AMT-4 permanent magnet test system showed that the coercivity of the resultant magnet was 14.8 kOe, which was much lower than that of Example 5.

### Comparative Example 15

The Comparative Example 15 differed from Example 5 in the diffusion source used in the first-step diffusion, which was represented by Pr_{0.52}La_{0.37}Ga_{0.11}. The diffusion source in the first-step diffusion was 2.0% by weight of the sintered substrate magnet. The test results of the AMT-4 permanent magnet test system showed that the coercivity of the resultant magnet was 11.9 kOe, which was much lower than that of Example 5.

### Comparative Example 16

The Comparative Example 16 differed from Example 5 in the diffusion temperature in the first-step diffusion. A two-step diffusion method was used, where the first-step diffusion was performed with Nd_{0.18}Pr_{0.6}La_{0.11}Ga_{0.11} at 590° C. for 6 h, and the second-step diffusion was performed with Nd_{0.1}Pr_{0.48}Ce_{0.06}Dy_{0.13}Tb_{0.07}Cu_{0.16} at 850° C. for 6 h. The magnet was then subjected to tempering at 520° C. for 3 h to obtain the resultant magnet which was tested using an AMT-4 permanent magnet test system. The test results of the AMT-4 permanent magnet test system showed that the coercivity of the resultant magnet was 14.2 kOe, which was much lower than that of Example 5.

In the method provided in the disclosure, the composition of the sintered substrate magnet and the multi-step diffusion are specially designed, where light rare earths with low melting point or their alloys are first used for GBD, and then light-heavy rare-earth combination or their alloys for GBD, thereby obtaining the Nd/Pr-rich and Dy/Tb-rich double magnetically hardening shell layers in the main phase grains of the misch-metal permanent magnetic material. The multi-step diffusion method modifies the microstructure of the misch-metal permanent magnetic material and forms continuous non-ferromagnetic grain boundary phases such as La/Ce-rich RE₆(Fe,Ga,Al,Cu)₁₄, which can effectively weaken the short-range exchange coupling between the hard magnetic main-phase grains, thereby obtaining the misch-metal permanent magnetic material with high coercivity.

Described above are merely some embodiments of the disclosure, which are not intended to limit the disclosure. Any modifications and replacements made by those skilled in the art without departing from the spirit of the disclosure should fall within the scope of the disclosure defined by the appended claims.

What is claimed is:

1. A method for preparing a misch-metal permanent magnetic material based on sintering and multi-step diffusion, comprising:
(1) subjecting a raw misch-metal permanent magnetic material to induction melting, strip casting, hydrogen decrepitation, jet milling, magnetic alignment, isostatic pressing and sintering to obtain a sintered substrate magnet;
(2) preparing at least one first diffusion source and a second diffusion source, wherein the at least one first diffusion source is each independently a light rare-earth metal or an alloy thereof, and the second diffusion source is a light-heavy rare-earth combination or an alloy thereof;
(3) subjecting the sintered substrate magnet to a first vacuum diffusion with the at least one first diffusion source to obtain a first intermediate product, wherein each of the at least one first diffusion source is less than 3% by weight of the sintered substrate magnet, and the first vacuum diffusion is performed at 600-950° C. for 1-6 hours;
(4) subjecting the first intermediate product to a second vacuum diffusion with the second diffusion source to obtain a second intermediate product; wherein the second diffusion source is less than 1% by weight of the sintered substrate magnet, and the second vacuum diffusion is performed at 800-950° C. for 2-10 hours; and
(5) subjecting the second intermediate product to tempering at 450-650° C. for 0.5-5 hours to obtain the misch-metal permanent magnetic material.

2. The method of claim 1, wherein composition of the sintered substrate magnet, in weight percentage, is [A₁₋ₐ(Ce₁₋ₓMMₓ)ₐ]_{b}Fe_{bal}R_{c}B_{d}GaₑAl_{f}, wherein A is selected from the group consisting of neodymium (Nd), praseodymium (Pr) and a combination thereof; Ce represents cerium element; MM is a misch-metal comprising 50-60% by weight of Ce, 20-35% by weight of lanthanum (La), 5-10% by weight of Pr, 10-20% by weight of Nd, and less than 2% by weight of other impurity elements; Fe represents iron element; R is selected from the group consisting of cobalt (Co), nickel (Ni), copper (Cu), molybdenum (Mo), niobium (Nb), silicon (Si), titanium (Ti), vanadium (V), zirconium (Zr) and a combination thereof; B represents boron element; Ga represents gallium element; Al represents aluminum element; and a, x, b, c, d, e and f satisfy the following conditions: 0.5≤a≤1, 0.5≤x≤0.95, 30≤b≤35, 0.2≤c≤3, 0.80≤d≤1, 0.2≤e≤2, 0.1≤f≤1, and 0.4≤e+f≤2.5.

3. The method of claim 2, wherein 0.7≤a≤1, 0.7≤x≤0.85, 31≤b≤32.5, 0.7≤c≤1.5, 0.88≤d≤0.95, 0.3≤e≤0.6, 0.2≤f≤0.7, and 0.5≤e+f≤1.3.

4. The method of claim 1, wherein the at least one first diffusion source, in weight percentage, is each independently A1_{g}M1_{1-g}, wherein A1 is selected from the group consisting of Nd, Pr, Ce, La and a combination thereof; a weight percentage of Nd and/or Pr in A1 is higher than 60%; and M1 is selected from the group consisting of A1, Cu, Ga and a combination thereof; and
the second diffusion source, in weight percentage, is A2ₕA3ᵢM2₁₋ₕ₋ᵢ, wherein A2 is selected from the group consisting of Nd, Pr, Ce, La and a combination thereof; A3 is selected from the group consisting of dysprosium (Dy), terbium (Tb) and a combination thereof; and M2 is selected from the group consisting of Al, Cu, Ga, Hydrogen (H) and a combination thereof; and g, h, and i satisfy the following conditions: 0.6≤g≤1, 0.4≤h≤0.8, and 0.1≤i≤0.6.

5. The method of claim 1, wherein the number of the at least one first diffusion source is 1-3, and 1-3 first diffusion sources vary in composition; and in step (3), the first vacuum diffusion is performed 1-3 times respectively with the 1-3 first diffusion sources.

6. The method of claim 1, wherein the first vacuum diffusion and the second vacuum diffusion are each performed at a furnace pressure of ≤10⁻³ Pa.
